(19) United States
(12) Patent Application Publication
(10) Pub. No.: US 2019/0261813 A1
(43) Pub. Date: Aug. 29, 2019

(54) CONNECTED COOKING DEVICE AND METHOD OF USE

(71) Applicants: Déric RUSSIER, Saint Privat Des Vieux (FR); Jonathan RUSSIER, Saint Privat Des Vieux (FR)

(72) Inventors: Déric RUSSIER, Saint Privat Des Vieux (FR); Jonathan RUSSIER, Saint Privat Des Vieux (FR)

(21) Appl. No.: 16/348,160

(22) PCT Filed: Nov. 3, 2017
(86) PCT No.: PCT/FR2017/053018

§ 371 Date: May 8, 2019

(30) Foreign Application Priority Data
Nov. 8, 2016 (FR) 1660800

(51) Int. Cl. A47J 36/32; A47J 27/12; F24C 7/08

(52) U.S. Cl. CPC A47J 36/321; F24C 7/082; A47J 27/12

(57) ABSTRACT

The connected cooking device (10) that comprises no physical user interface, comprises:
a base (11) attached to the ground,
a support (20) for a heating means (32), attached to the base by internal connection means (12), provided with an opening and a lock (38) for opening said opening,
a power supply (41) for powering the heating means,
an electronic module (40) for short-range communication for communicating with a communicating mobile terminal (50), the electronic module controlling the powering of the heating means and the unlocking of the lock depending on the messages exchanged with the communicating mobile terminal.

In certain embodiments, the electronic module is configured to check the presence of the communicating mobile terminal near the cooking device, by exchanging messages with the communicating mobile terminal and, in the event that the communicating mobile terminal is absent, to stop powering the heating means.

### TECHNICAL FIELD OF THE INVENTION

The present invention concerns a connected cooking device and a method of use for such a device. It applies, in particular, to providing barbecues for public use located in a public place, leisure center, campsite, etc.

### STATE OF THE ART

The barbecues currently provided for the public are of low value, to limit thefts, and in poor condition, few users taking the time to clean them before they leave. This gives local authorities and tourism professionals little incentive to install them.

### SUBJECT OF THE INVENTION

The present invention aims to remedy all or part of these drawbacks.

To this end, according to a first aspect, the present invention envisages a device as defined in claim 1.

Thanks to these provisions, a user equipped with a communicating mobile terminal can use the cooking device. This communicating mobile terminal is identified, so that the user is encouraged to clean the cooking device before leaving, or risk being refused further use of the cooking device, or of all cooking devices that are the subjects of the present invention.

In some embodiments, the electronic module is configured to check the presence of the communicating mobile terminal near the cooking device, by exchanging messages with the communicating mobile terminal, and to stop powering the heating means if the communicating mobile terminal is not present.

Thanks to these provisions, even if the user has forgotten to switch the cooking means off, the electronic module turns it off when the user leaves.

In some embodiments, the electronic module comprises an emitter-receiver utilizing the Bluetooth communication protocol.

Thanks to these provisions, the distance between the communicating mobile terminal and the device is both fairly large, of the order of one to several tens of meters, which leaves the user freedom of movement, and fairly small, obliging the user to remain within sight of the device. Security is thus strengthened.

In some embodiments, the electronic module is configured to authenticate the communicating mobile terminal and to control the power supply of the heating means only if the communicating mobile terminal is authenticated.

Thanks to these provisions, the user of the device can be identified. He is therefore encouraged to respect the integrity and condition of the device during its use.

In some embodiments, the heating means comprises a cooktop along a main plane and, in a plane substantially parallel to the main plane, a periphery which is, at all points, at least fifteen centimeters distant from the heating means.

Thanks to these provisions, the risks of burns to the hand or body of a user, especially a very young child, are reduced.

In some embodiments, the device comprises a remote server configured to communicate a code to the communicating mobile terminal, the electronic module checking the code received by the communicating mobile terminal before controlling the power supply of the heating means.

Thanks to these provisions, the service offered by a plurality of devices spread over an area can be managed by a single server. In addition, security of the devices is increased since, generally, a server is better protected than a connected device.

In some embodiments, the server is configured to receive, from the communicating mobile terminal, at least one rating or one photograph, and to keep in memory each rating or photograph received matched to an identifier of the user.

Thanks to these provisions, each user can rate the previous user of the device and can confirm that he cleaned the device before leaving.

In some embodiments, the opening has a moving portion comprising the heating means.

Thanks to these provisions, the opening of the device enables easy access to the components of the heating means and provides a large opening for the operator responsible for maintaining or repairing the device.

In some embodiments, the device that is the subject of the present invention comprises a collector of grease flowing over the heating means and a fill sensor detecting the fullness of the grease collector, the electronic module being configured to send an alert message if the grease collector is full.

According to a second aspect, the present invention envisages a method as defined in claim 22.

As the features, advantages and aims of this method are similar to those of the device that is the subject of the present invention, they are not repeated here.

### BRIEF DESCRIPTION OF THE FIGURES

Other advantages, aims and particular features of the present invention will become apparent from the description that will follow, made, as a non-limiting example, with reference to drawings included in an appendix, wherein:

FIG. 1 represents, in a cross-section elevation view, a particular embodiment of the device that is the subject of the present invention, in a configuration of use;

FIG. 2 represents an enlarged detail of FIG. 1;

FIG. 3 represents, in a cross-section top view, the device shown in FIG. 1;

FIG. 4 represents, in a cross-section elevation view, the device shown in FIGS. 1 to 3, in a maintenance or repair configuration;

FIG. 5 represents an enlarged detail of FIG. 4;

FIG. 6 represents, in a cross-section elevation view, the electronic elements for utilizing the device that is the subject of the present invention;

FIGS. 7 and 8 represent, in the form of logical diagrams, steps of the method of use of the device that is the subject of the present invention and operational steps for the device that is the subject of the present invention.

### DESCRIPTION OF EXAMPLES OF REALIZATION OF THE INVENTION

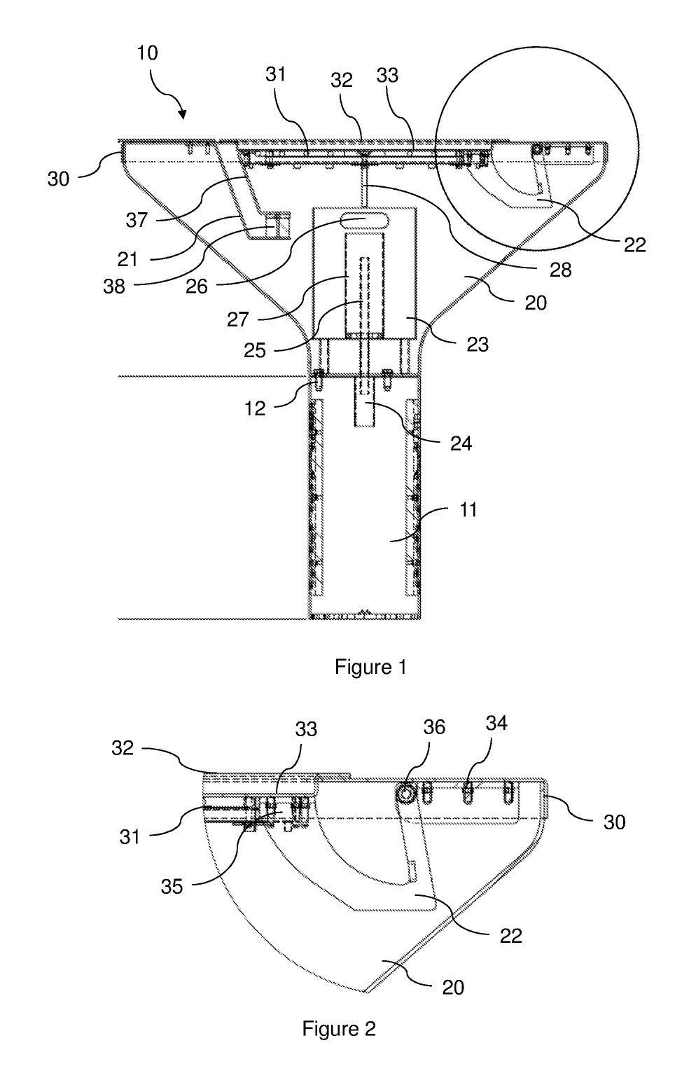

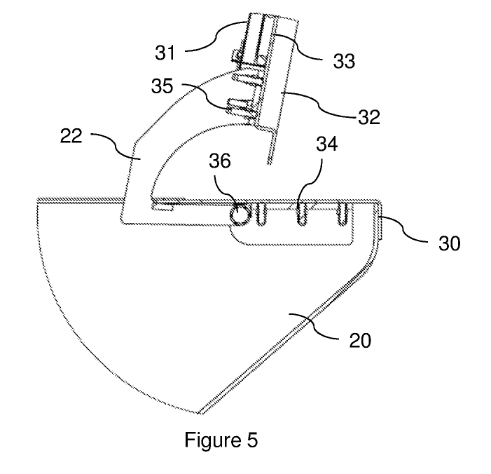

FIGS. 1 to 5 show the mechanical and electromechnical components of a connected cooking device 10. This device 10 comprises no physical user interface allowing the user to operate the device: no button, no keyboard, no opening.

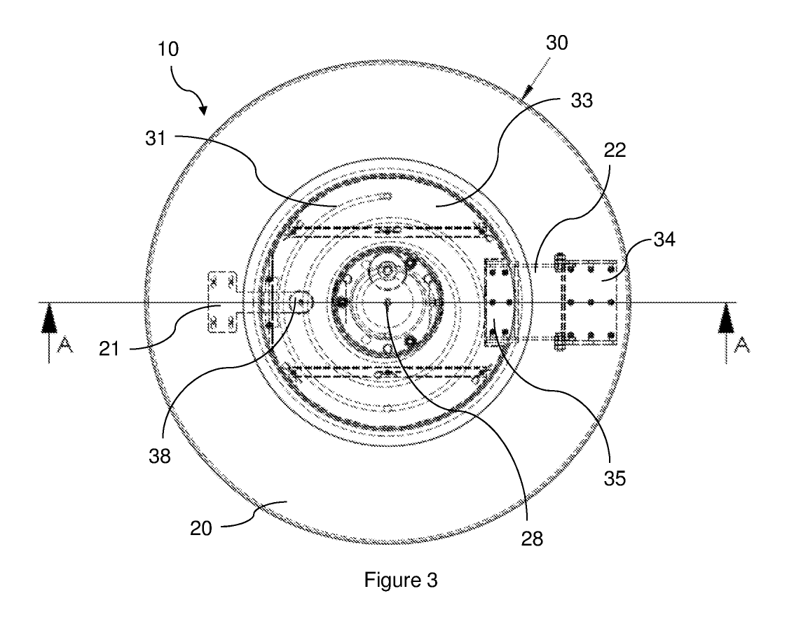

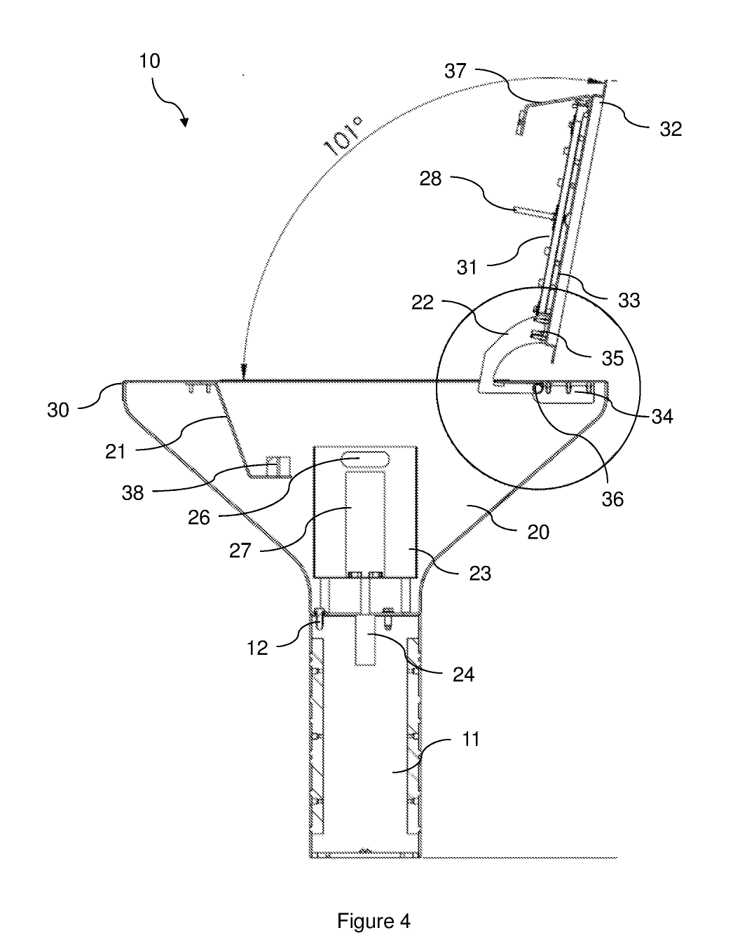

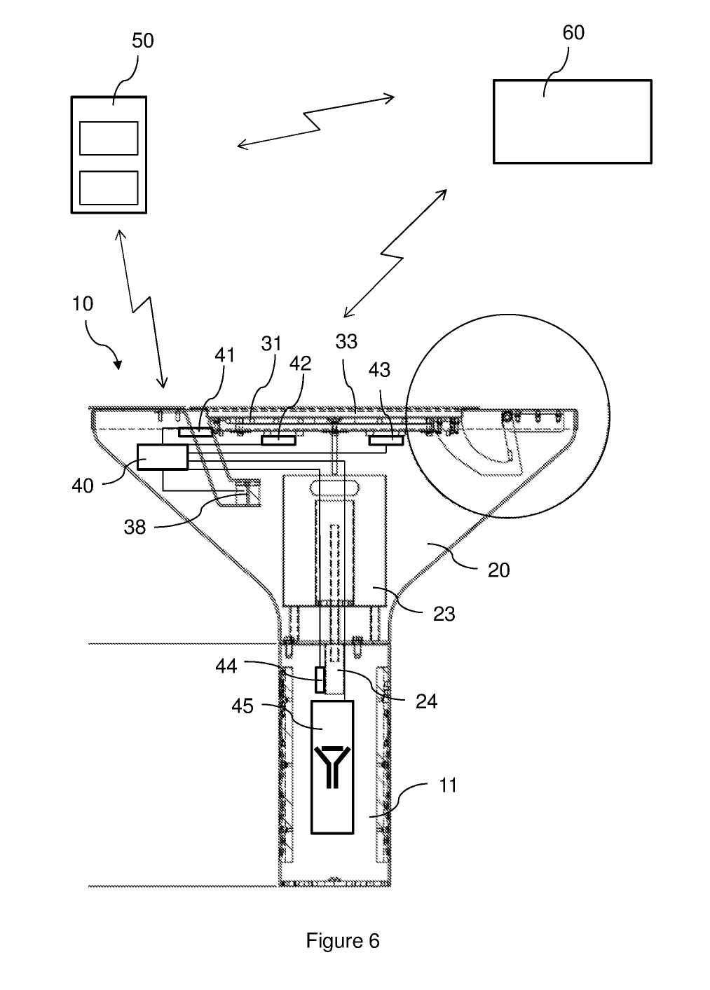

FIG. 3 shows the cross-section plane A-A along which FIGS. 1, 2, 4 and 5 are shown. The circles on the right in FIGS. 1, 4 and 6 show the details represented in FIGS. 2 and 5.

The device 10 comprises:
a base 11 attached to the ground;
a support 20 for a heating means 32, attached to the base 11 by internal connection means 12, provided with an opening and a lock 38 for opening said opening.

In some variants, the base 11 and the support 20 form only one or two parts extending from the ground.

The base 11 is fixed to the ground, for example by means of a concrete topping (not shown), according to known techniques. In FIGS. 1 to 5, the support 20 is fixed to the base 11 by bolts 12. The support 20 has a generally frustoconical shape. The device 10 has a height and diameter of the order of 90 to 100 centimeters. Preferably, the heating means 32 comprises a cooktop 33 along a main plane, horizontal in this case, and, in a plane substantially parallel to the main plane, a periphery 30 which is, at all points, at least fifteen centimeters, preferably twenty centimeters, distant from the heating means. The risks of burns to the hand or body of a user, especially a very young child, are reduced.

The cooktop 33 is provided with heating elements 31 and a thermostat to maintain the temperature of the cooktop at a substantially constant temperature, for example 100 degrees. The circular cooktop 33 has a slope towards its center and a duct 28 for evacuating grease flowing over its surface. The grease passing through the duct 28 is collected in a removable collector 23, held in position by rods 25 and frustocylindrical in shape, fitted with handles 26 and an overflow 27 discharging into a fixed tank 24.

In this case, the lock 38 is an electromagnet which remains closed if there is no electrical power. This electromagnet 38 is borne by a fixed arm 21. The device is opened by rotating the heating means 32 around an axis of rotation 36 (see FIGS. 2 and 5). An arm 37 attached to the heating means is held in position by the electromagnet 38.

As shown in FIGS. 2 and 5, the rotation of the heating means 32 is restricted, in one direction, by the shape of the heating means, which rests on the upper surface of the support 20, and, in the opposite direction, by the shape of a hinge 22. The hinge 22 comprises an attachment 34 to the support 20 and an attachment 35 to the heating means 32.

Thus, the opening has a moving portion comprising the heating means 32. The opening of the device 10 therefore enables easy access to the components of the heating means 32 and provides a large opening for the operator responsible for maintaining or repairing the device 10.

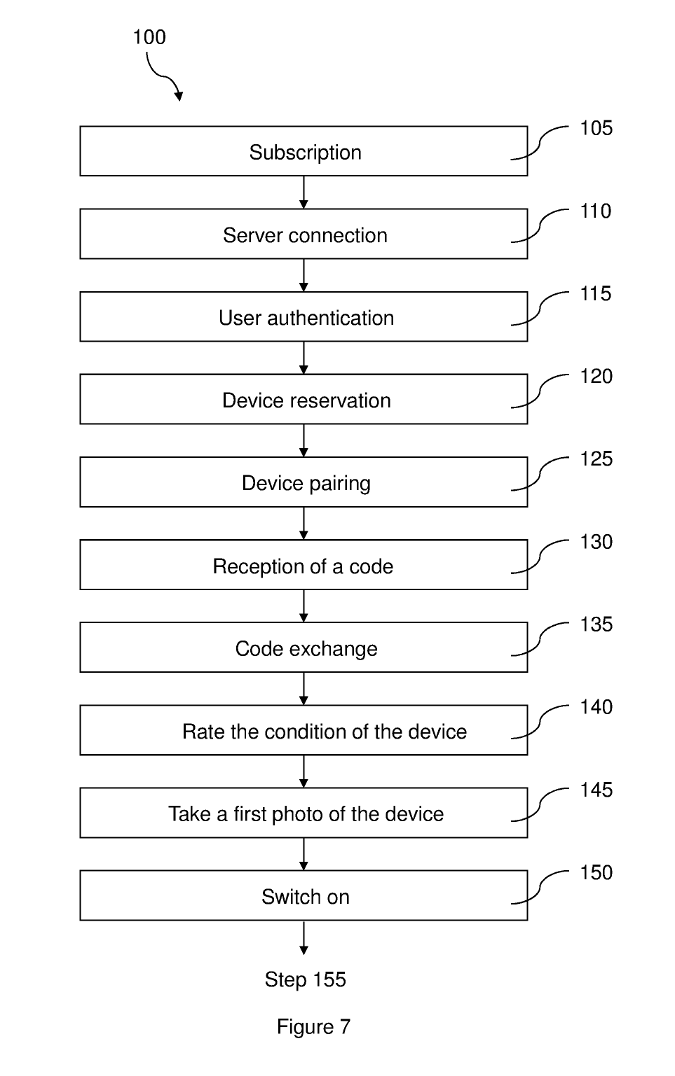

FIG. 6 shows the electronic components enabling the operation of the device 10. These components comprise:
the electromagnet 38;
an electronic control module 40;
a power supply 41 for powering the heating elements 31;
a temperature sensor 42 for controlling the temperature of the cooktop 33;
a sensor 43 for detecting the presence of food on the cooktop 33 and/or soiling of the cooktop 33;
a fill sensor 44 detecting the fullness of the grease collector 23; and
an illuminated panel 45, lit by a light source (not shown).

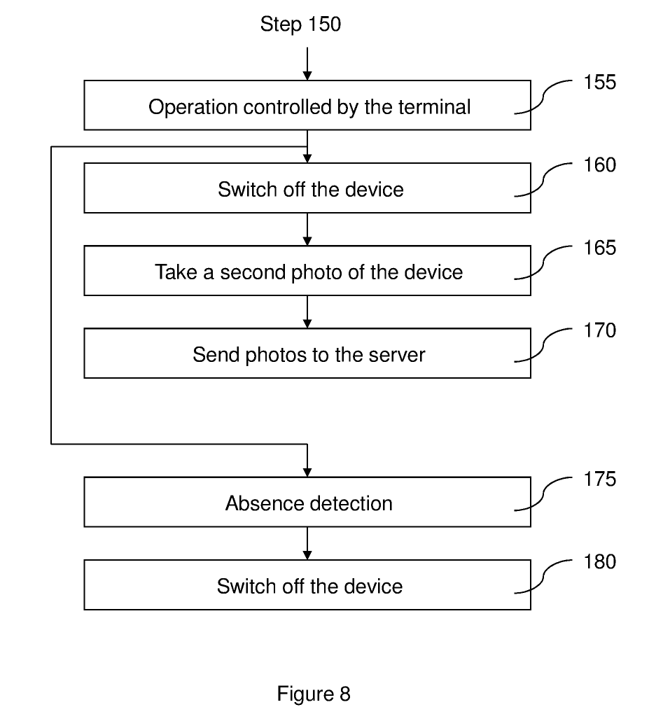

The electronic control module 40 comprises an emitter-receiver for short-range communication with a communicating mobile terminal 50, for example a mobile phone or a tablet. In some preferred embodiments, the electronic control module also comprises an emitter-receiver for communicating, for example over a mobile phone network, with a remote server 60, which manages a plurality of devices 10. It is noted that this second connection, between the device 10 and the server 60, is not essential, as the communicating mobile terminal 50 can be used to establish this connection, indirectly or, if there is no telephone network, to convey an alert message until a connection with the server 60 is available. The electronic module 40 controls the powering of the heating means 32 and the unlocking of the lock 38 based on messages exchanged with the communicating mobile terminal, as described with reference to FIGS. 7 and 8.

The remote server 60 is configured to communicate a code to the communicating mobile terminal 50, the electronic module 40 checking the code received by the communicating mobile terminal 50 before controlling the power supply of the heating means 32. The service offered by a plurality of devices 10 spread over an area can be managed by a single server 60. In addition, security of the devices 10 is increased.

FIGS. 7 and 8 detail, more generally, steps in the operation of the electronic module 40 and of the device 10, with regard to the communicating mobile terminal 50 and the remote server 60.

The role of the electromagnet 38 has already been described. However, the electromagnet also serves as a detector of an intrusion into the device 10. In effect, the response of the electromagnet 38 differs, depending on whether the metal arm 37 is in contact with its upper surface, or not. If an intrusion, i.e. an opening of the device not authorized by an access code, is detected then the electronic module 40 causes an alert message to be sent to the server 60.

The power supply 41 for powering the heating elements 31 is connected to the mains power. The power supply 41 supplies electricity to all the electrical components of the device, possibly including the communicating mobile terminal, by means of an inductive power supply (not shown). The power supply 41 is protected according to known techniques.

The temperature sensor 42 enables the electronic module 40 to maintain the temperature of the cooktop 33 at a constant level, for example chosen by the user via a user interface displayed on the communicating mobile terminal 50.

The sensor 43 for detecting the presence of food on the cooktop 33 and/or soiling of the cooktop 33 is, for example, an emitter-receiver of mechanical waves on the surface of the cooktop 33. In effect, it is known that mechanical waves are partially absorbed by food or grease. The mechanical waves are, for example, generated by a piezoelectric crystal. The absence of food during a predefined length of time, for example two minutes, or the presence of abnormal soiling, triggers the emission of an alert message by the electronic module 40.

The fill sensor 44 for the grease collector 23 is, for example, a known type of gauge, for example, a weight, pressure, conduction or vibration damping sensor. In the embodiment shown in FIG. 6, the fill sensor 44 is located on the reservoir 24. Therefore, when the overflow 27 causes grease to discharge into the tank 24, the fill sensor 44 emits a fullness detection signal. This signal leads to the electronic module 40 sending an alert message to the server 60. In other embodiments, the fill sensor detects fullness when the level or weight of grease in the grease collector 23 is greater than a predefined value, for example three-quarters of the maximum capacity of the grease collector 23.

On reception of one or other of the alert messages described above, the server triggers the intervention of a maintenance, safety and/or repair operator.

The light source of the illuminated panel 45 is preferably a light-emitting diode (also called “LED”) light source. Preferably, these diodes are able to emit different light colors. Therefore, the color of the illuminated panel 45 allows the electronic module to indicate the status of the device:
available;
already reserved;
connected;
heating; and/or
setpoint temperature reached by the cooktop.

In the embodiment shown, the illuminated panel bears a logo and/or instructions for using the device 10.

Preferably, a heat seal, thermal brake and/or isothermal tank (not shown) isolates the heating elements 31, cooktop 33 and grease collector 23, on the one hand, from the rest of the volume of the device 10. In this way, the risks of a user being burnt through contact with the side surface of the device 10 are reduced.

As illustrated with regard to FIGS. 7 and 8, in modes of use of the device 10, during a step 105, the user subscribes to the service providing access to the cooking devices 10. For this, the user supplies the server 60 with contact details, in particular telephone details of the communicating mobile terminal 50, and possibly payment means data. During a step 110, the user connects to the server 60, for example through a page of a website or via a short message (referred to as an “SMS” or “text message”), using the communicating mobile terminal 50. During a step 115, the server 60 authenticates the communicating mobile terminal 50, for example by means of its telephone number or by an identifier (“login”) and password. During a step 120, the user reserves a device, for example after having viewed on a map a set of devices that have not yet been reserved for a time-slot he has specified.

During a step 125, the communicating mobile terminal 50 is paired with the device 10 reserved, according to known pairing techniques, in particular according to the Bluetooth (registered trademark) protocol.

During a step 130, the communicating mobile terminal receives a one-time challenge code (i.e. usable only once) from the electronic module 40 of the device 10. This code is, for example, a random code or a code dependent on the time, to the exact second.

During a step 135, the communicating mobile terminal 50 transmits this challenge code to the server 60 and receives, in return, a response code, calculated from the challenge code, according to an algorithm known to the module 40 and server 60. The electronic module 40 checks the response code received.

In this way, the electronic module 40 is configured to authenticate the communicating mobile terminal 50 and to control the power supply of the heating means 32 only if the communicating mobile terminal 50 is authenticated. In this way, the user of the device can be identified. He is therefore encouraged to respect the integrity and condition of the device 10 during its use.

During a step 140, the user rates the condition of the device 10, for example with a rating between 1 and 5. During a step 145, the user takes a first photo of the device 10, with the communicating mobile terminal 50. This photo must include the surface of the cooktop 33 and show the condition in which the user found the device 10 when he arrived.

During a step 150, the electronic module 40 authorizes the heating element 31 to be switched on and the cooktop 33 to be heated to the setpoint temperature.

During a step 155, the device 10 operates under the control of the communicating mobile terminal 50.

During a step 160, the user causes the device 10 to be switched off.

During a step 165, the user takes a second photo of the device 10 to show the condition in which he left it when he departed.

During a step 170, the communicating mobile terminal 50 sends the photos and the rating to the server 60. The server 60 is configured to receive, from the communicating mobile terminal 50, at least one rating or one photograph, and to keep in memory each rating or photograph received matched to an identifier of the user. In this way, each user can rate the previous user of the device and can confirm that he cleaned the device before leaving.

The electronic module 40 continually checks that the pairing with the communicating mobile terminal is still active. If the module 40 determines that the communicating mobile terminal 50 is no longer paired, during a step 170, then during a step 175 the module 40 causes heating of the cooktop 33 to stop.

The electronic module 40 is therefore configured to check the presence of the communicating mobile terminal 50 near the cooking device 10, by exchanging messages with the communicating mobile terminal, and to stop powering the heating means 32 if the communicating mobile terminal is not present. In this way, even if the user has forgotten to switch the cooking means off, the electronic module 40 turns it off when the user leaves. Utilization of the Bluetooth communication protocol means that the communicating mobile terminal 50 can be at a distance from the device 10 that is both:
fairly large, of the order of one to several tens of meters, which leaves the user freedom of movement; and
fairly small, obliging the user to remain within sight of the device. Security is thus strengthened.

As can be seen by reading the description above, a user equipped with a communicating mobile terminal 50 can use the connected cooking device 10. The communicating mobile terminal 50 is identified, so that the user is encouraged to clean the cooking device 10 before leaving, or risk being refused further use of the cooking device 10, or of all similar cooking devices 10.

In some embodiments (not shown):
the cooktop comprises an opening and an inclination of the surface of the cooktop towards this opening allowing liquid on the cooktop to be evacuated, and, downstream from the cooktop opening, a depth filtration filter and a filter clogging detector, the electronic module being designed to remotely communicate a notification indicating that the filter is clogged. The usual method is filtration by a grease separator. This system has its limitations, which are that the non-grease juices can be messy and smelly, and that if a user uses a degreasing agent to clean the hob then the greases are dissolved, escape from the filter and end up released into the environment. Preferably, the cooking device comprises, downstream from this hole, a filter that combines various filter elements, for example activated carbon, pozzolan and/or diatomaceous earth. This filter allows the grease and non-grease residues to be retained, and clear water to be released at the base of the cooking device. As this system is a depth filtration system, the filter's capacity is estimated to be several years. If this filter is clogged, a float detects the level of water retained, and the cooking device remotely transmits, for example by means of a mobile phone (with an on-board SIM card, acronym for subscriber identification module), a notification indicating that the filter is clogged.
the cooking device preferably embeds a communication card using a mobile phone protocol (for preference an SMS card), which makes it possible to carry out remote updates of both its firmware and the values of its operating parameters.
the cooking device is equipped with a geolocation chip. It can therefore be located if stolen.
the cooking device is equipped with at least one detector of mechanical vibrations above a predefined intensity. Therefore, if there is deliberate degradation, or an attachment of insufficient quality, the electronic module is configured to remotely communicate a notification when the detector detects mechanical vibrations above the predefined intensity.
a cooking device with a defective mobile phone card, and a user with a phone without a phone card, can nevertheless communicate and cooking can be performed, thanks to communication using the Bluetooth protocol.
the cooking device incorporates a means for quickly cooling the cooktop:
   the cooling means comprises fins on the lower surface of the cooktop, a heat-transfer medium and a means for respectively moving the heat-transfer medium and the fins of the cooktop.

For example, the cooktop bears, on its lower surface, a system of fins which are preferably immersed in a heat-transfer medium such as liquid silicone. To heat the hob, the silicone is heated and provides the thermal inertia favorable to good-quality cooking. When the user disconnects, the silicone bath is lowered, for example by a ballast system, and forced ventilation cools the fins. In this way, a non-dangerous temperature can be reached in a shorter length of time. A variant of this system is to consider that the silicone bath is always hot (and insulated in a thermos) and it is only the system of raising and lowering the liquid silicone that serves to regulate the temperature. The advantage of this system is to have an extremely rapid rise in temperature, with energy optimization (the energy remaining at the end of cooking is not lost). Another advantage of this system is the possibility of reducing the power needed for a cooking device, by using the heat-transfer fluid in a buffer. This makes it possible to tackle the problem experienced in facilities that have limited electrical power available.
the means for cooling the cooktop comprises a system for blowing hot air, to heat the cooktop, or cold air, to cool the cooktop. The hob is the thinnest possible, and has a hot-air system (heat gun type) that heats the hob, with PWM (acronym for pulse width modulation) for regulation. When the hob needs to be cooled, the same gun blows the ambient air recovered and vented to the outside of the cooking device.
another function is “powersharing”, which enables several cooking devices to synchronize with each other for energy needs so the supply is never exceeded. The electronic module 40 for communication is configured to communicate with at least one corresponding cooking device, and a means for sharing energy so that the total consumption of the various cooking devices in communication remains below the sum of the rated power consumed by the cooking devices in communication. For example, the first cooking devices that receive a setpoint temperature, and for which the sum of the rated consumptions is less than the supply, carry out their heating up, and then maintain the temperature, by successive heating, leaving a cooking device sufficient energy available to perform its own heating up, and so on.
the cooking device is equipped with a PID (proportional integral derivative) system for regulating the temperature, and a static relay in order to obtain extremely rapid, silent and long-lasting switches. It should be noted that this relay is equipped with a zero-crossing, which makes it possible to have interruptions that do not generate ECM (electromagnetic compatibility) interference.
for the closure system, the top plate is fixed invisibly, a strong magnet being required to actuate the latch.
the cooktop comprises a hot area and a temperate area, formed from a single sheet. Heat transmission is slowed significantly thanks to the creation of cut-outs in the cooktop, these cut-outs increasing the necessary path for the heat, and thus forming thermal resistances. One variant of this system is to mount a ventilated heat sink on the lower surface of the temperate area.
an embedded hardware system measures the temperature of the electronic board and, if a critical temperature is reached, deactivates the components until a reasonable temperature is obtained, by means of a fan that forces air across the sensitive components.
a light source, for example comprising light-emitting diodes, is incorporated, for example in the base. This light source indicates a status, for example by the color of the light and whether it flashes or not. For example:
   Green: The cooking device is available;
   Flashing red: The cooking device is very hot;
   Blue: The cooking device is connected by a wireless connection (Bluetooth) to the user's terminal;
   Orange: The cooking device is reserved;
   Switched off: The cooking device has broken down or been deactivated by the administrator,
a software system for identifying cooking devices. A user who arrives in a facility in which there are several cooking devices can freely choose a cooking device, for example one cleaner or closer than the others. The user opens the application, which sends a signal by wireless communication (Bluetooth): the light sources of the available cooking devices therefore take on differentiating colors. The application then proposes a choice of the cooking device color desired. Once the cooking device has been selected, the others turn back to green, and the one selected turns blue, while waiting to receive the instruction with the desired temperature.

1. A connected cooking device that comprises no physical user interface, comprising:
a base attached to the ground;
a support for a heating means, attached to the base by internal connection means, provided with an opening and a lock for opening said opening;
a power supply for powering the heating means;
an electronic module for short-range communication for communicating with a communicating mobile terminal, the electronic module controlling the powering of the heating means and the unlocking of the lock depending on the messages exchanged with the communicating mobile terminal.

2. A device according to claim 1 wherein the electronic module is configured to check the presence of the communicating mobile terminal near the cooking device, by exchanging messages with the communicating mobile terminal, and to stop powering the heating means if the communicating mobile terminal is not present.

3. (canceled)

4. A device according to claim 1 wherein the electronic module is configured to authenticate the communicating mobile terminal and to control the power supply of the heating means only if the communicating mobile terminal is authenticated.

5. A device according to claim 1, wherein the heating means comprises a cooktop along a main plane, and the device having, in a plane substantially parallel to the main plane, a periphery which is, at all points, at least fifteen centimeters distant from the heating means.

6. A device according to claim 5 wherein the cooktop comprises an opening and an inclination of the surface of the cooktop towards this opening allowing liquid on the cooktop to be evacuated, and, downstream from the cooktop opening, a depth filtration filter and a filter clogging detector, the electronic module being designed to remotely communicate a notification indicating that the filter is clogged.

7. A device according to claim 6, which comprises a means for cooling the cooktop, and wherein the cooling means comprises:
a system for blowing hot air, to heat the cooktop, or cold air, to cool the cooktop or;
fins on the lower surface of the cooktop, a heat-transfer medium and a means for respectively moving the heat-transfer medium and the fins of the cooktop.

8. (canceled)

9. (canceled)

10. A device according to claim 5 wherein the cooktop comprises a hot area and a temperate area, formed from a single sheet, having cut-outs separating the hot area and the temperate area

11. A device according to claim 5, wherein the cooktop comprises a hot area and a temperate area, a heat sink on the lower surface of the temperate area.

12. A device according to claim 1, which comprises a remote server configured to communicate a code to the communicating mobile terminal, the electronic module checking the code received by the communicating mobile terminal before controlling the power supply of the heating means.

13. A device according to claim 12 wherein the server is configured to receive, from the communicating mobile terminal at least, one rating or one photograph and to keep in memory each rating or photograph received matched to an identifier of the user.

14. A device according to claim 1, wherein the opening has a moving portion comprising the heating means.

15. A device according to claim 1, which comprises a collector of grease flowing over the heating means and a fill sensor detecting the fullness of the grease collector, the electronic module being configured to send an alert message if the grease collector is full.

16. (canceled)

17. A device according to claim 1, which also comprises at least one detector of mechanical vibrations above a predefined intensity, the electronic module being configured to remotely communicate a notification when the detector detects mechanical vibrations above the predefined intensity.

18. A device according to claim 1, wherein the electronic module for communication is configured to communicate with at least one corresponding cooking device, and a means for sharing energy so that the total consumption of the various cooking devices in communication remains below the sum of the rated power consumed by the cooking devices in communication.

19. (canceled)

20. A system for managing access to at least one connected cooking device, which comprises at least one device according to claim 1 and a remote server configured to communicate a code to the communicating mobile terminal, the electronic module checking the code received by the communicating mobile terminal before controlling the power supply of the heating means.

21. A system according to claim 20, wherein the server is configured to receive, from the communicating mobile terminal, at least one rating or one photograph and to keep in memory each rating or photograph received matched to an identifier of the user.

22. A method of use for a connected cooking device that comprises no physical user interface, which device comprises a base attached to the ground, a support for a heating means, attached to the base by internal connection means, provided with an opening and a lock for opening said opening, and a power supply for powering the heating means, which method comprises:
a short-range communication step during which the device communicates with a communicating mobile terminal; and
a step of controlling the powering of the heating means and/or the unlocking of the lock depending on the messages exchanged with the communicating mobile terminal.

23. A method according to claim 22, which comprises a step of communicating, by a remote server of the connected cooking device, a code to the communicating mobile terminal, the step of controlling the powering of the heating means comprising a step of checking the code received by the communicating mobile terminal before controlling the power supply of the heating means.

24. A method according to claim 23, which comprises a step of the server receiving, from the communicating mobile terminal, at least one rating or one photograph and a step of storing each rating or photograph received matched to an identifier of the user.

25. A method according to claim 22, which comprises a step of capturing the fullness of a collector of grease flowing over the heating means and, if the grease collector is full, a step of sending an alert message.
